(19) United States
(12) Patent Application Publication
(10) Pub. No.: US 2025/0232318 A1
(43) Pub. Date: Jul. 17, 2025

(54) System and Related Methods for Verification and Protection of Professional License Information

(71) Applicant: Bo Ying Liu, Fontana, CA (US)

(72) Inventor: Bo Ying Liu, Fontana, CA (US)

(21) Appl. No.: 18/411,079

(22) Filed: Jan. 12, 2024

(51) Int. Cl. G06Q 30/018; G06F 21/60; G06F 21/62

(52) U.S. Cl. CPC G06Q 30/0185; G06F 21/602; G06F 21/6218

(57) ABSTRACT

This invention pertains to a web-based system for the protection and verification of professional license information. The system incorporates a secure database for storing user data related to licensed professionals and government plan checkers, along with an associated array of projects. Servers in communication with this database are responsible for receiving license data from professionals' user devices, verifying the authenticity of this data via a third-party service, and storing the verified information. The servers are also programmed to process verification requests from plan checker accounts, which may query a project against a professional's license details. Upon such a request, the servers compare the submitted project and license identifiers with the database records and provide verification outcomes. The system ensures that projects are legitimately authorized by the licensed professionals linked to the license identifiers, thereby enhancing the reliability of license verification processes.

### FIELD OF INVENTION

The present invention relates generally to web-based verification systems and methods within the field of professional licensure. Specifically, it relates to the secure validation of professional license stamps for authorized use in submitting official documents to government entities.

### BACKGROUND

The field of professional services, particularly in the realms of architecture and engineering, has long been safeguarded by the use of licensure as a means to ensure that practitioners are qualified and authorized to offer their services. Licensure is typically represented by a physical or digital stamp that professionals affix to their work, signifying their compliance with regulatory standards. However, this system has become vulnerable to misuse through the advent of digital technologies. There is a growing concern that contractors and homeowners may inadvertently engage unlicensed individuals who produce work that carries fraudulent representations of such licensure.

The digital representation of a professional's stamp has become susceptible to unauthorized duplication and misuse. Perpetrators of such fraud have been known to apply counterfeit digital stamps, emulating those of licensed professionals, onto work that has not been legitimately executed. This malpractice not only jeopardizes the safety and integrity of the resulting structures but also tarnishes the reputations of the professionals whose stamps have been mimicked. Furthermore, the entities responsible for reviewing and approving these documents, such as city hall plan checkers, lack a robust mechanism to discern the authenticity of the stamps they encounter on submitted plans.

These challenges have underscored the necessity for a system that can securely authenticate and guard the use of a professional's licensure stamp. The proposed system aims to create a secure and reliable environment where licensed professionals can confidently upload and associate their licensure with their work. Government plan checkers, in turn, would have the ability to cross-check and verify the authenticity of stamps on the plans they receive. This verification process serves as a critical barrier against the fraudulent use of licensure stamps and protects the interests of both professionals and the public. By addressing these issues, the system would enhance the reliability of licensure validation, thereby preserving the integrity of professional services and safeguarding public welfare.

It is within this context that the present invention is provided.

### SUMMARY

The present invention relates to a web-based system designed to validate and protect the integrity of professional license stamps used by licensed professionals in submitting official documents. This system provides an enhanced level of security and verification to mitigate the risk associated with unauthorized use of professional license information.

The invention comprises a secure database that maintains user information for both licensed professional accounts and government plan checker accounts. The database includes records of projects associated with each professional's account, facilitating clear and authorized use of professional license stamps. One or more servers, in secure communication with this database, are tasked with verifying the professionals' license information through a third-party service and, upon successful verification, storing this information associated with the professional's profile.

The servers are further configured to process verification requests from government plan checker accounts. These requests involve a professional's license details and a specific project identifier. The server compares the request against the database records to confirm if the project is officially listed under the professional's account, ensuring that only authorized documents bear the professional's stamp.

Key aspects of the invention include the ability for professionals to manage their license and project information through a user interface, and the ability for plan checkers to verify project authorization effectively. The system is designed to categorize user information by jurisdictional entities such as state or city or professional board under each state, and to log all verification activities for audit and compliance purposes.

The system also enables direct communication between plan checkers and professionals through the platform, enhancing the reliability of the verification process. Furthermore, the system employs robust security measures, including encryption, to protect sensitive data.

### BRIEF DESCRIPTION OF THE DRAWINGS

Various embodiments of the invention are disclosed in the following detailed description and accompanying drawings.

FIG. 1 presents a high-level system architecture, illustrating the interconnection of a secure database, servers, and user devices. It shows the communication setup between devices associated with licensed professionals and government plan checkers, all connected via a cloud network.

FIG. 2 depicts a flow process diagram that outlines the operational steps of the web-based system. This figure details the sequence from receiving and authenticating license information to the final verification step, highlighting the system's methodical approach to safeguarding professional license data.

FIG. 3 illustrates the interactive process flow between licensed professionals and government plan checkers within a web-based system, detailing steps for authenticating license information, storing credentials, and verifying project authorization through a secure database.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, “secure database” refers to a data storage system that employs one or more forms of security measures to protect data from unauthorized access or alterations. Such security measures may include, but are not limited to, encryption, access controls, secure communication protocols, and data integrity checks.

The term “user device” as described herein encompasses any electronic device that enables a user to interact with the web-based system. This may include personal computers, laptops, tablets, smartphones, or other mobile devices equipped with the capability to transmit and receive data over a network.

“Licensed professional account” as used herein denotes a digital profile within the web-based system that is associated with an individual or entity holding a valid professional license. The account may contain personal identification information, professional credentials, and project data.

The phrase “government plan checker account” refers to a digital profile set up for government employees or departments responsible for the review and approval of professional work, such as building plans. These accounts may have access to verification tools and functionalities pertinent to their role in the verification process.

“Third-party verification service” as used herein pertains to an external system or entity that provides services for validating the authenticity of professional licenses. This service operates independently of the user and the web-based system to provide an unbiased confirmation of licensure status.

“Verification request” as described herein is a query initiated by a government plan checker account that seeks to confirm the authenticity of a professional license stamp on a project. The request includes identifiers such as a project name or number and a license number or other professional identifier.

“Authenticate” and “verify” as used herein involve the processes of confirming the validity of provided information against established truths or standards. Authentication may include checking the accuracy of license information against official records, while verification may involve confirming the association of a project with a licensed professional's account in the system.

“User information” as described herein includes, but is not limited to, personal data, professional credentials, project lists, and any other relevant information provided by the user for the purpose of utilizing the system's services.

### DESCRIPTION OF DRAWINGS

The present disclosure relates to a web-based system designed to safeguard and authenticate professional license information, particularly in the context of official document submissions. This system addresses the growing concern over the unauthorized and fraudulent use of professional license stamps in various industries, including but not limited to architects, professional engineers, landscape architects, land surveyors and so on.

At the core of this invention is a secure database configured to store detailed user information, including accounts for licensed professionals and government plan checkers. This database not only houses personal and professional credentials but also maintains a record of authorized projects associated with each licensed professional account. Such a repository of information serves as the foundation for verifying the authenticity of professional work.

In tandem with the secure database, the system employs one or more servers that facilitate the key functions of the invention. These servers are in secure communication with the database and are programmed to perform specific operations critical to the system's functionality. The servers receive license information submitted by users through associated devices, authenticate this information via third-party verification services, and, upon successful verification, store the information in the secure database. This process ensures that only verified and legitimate professional information is maintained within the system.

Further, the servers are equipped to handle verification requests initiated by government plan checker accounts. These requests are made to ascertain the authenticity of a professional's license stamp on a project. The servers perform a comparative analysis of the project details and the professional's license information as stored in the database. Upon completing this comparison, the servers provide a verification result to the government plan checker account, confirming or denying the project's authorization by the licensed professional in question.

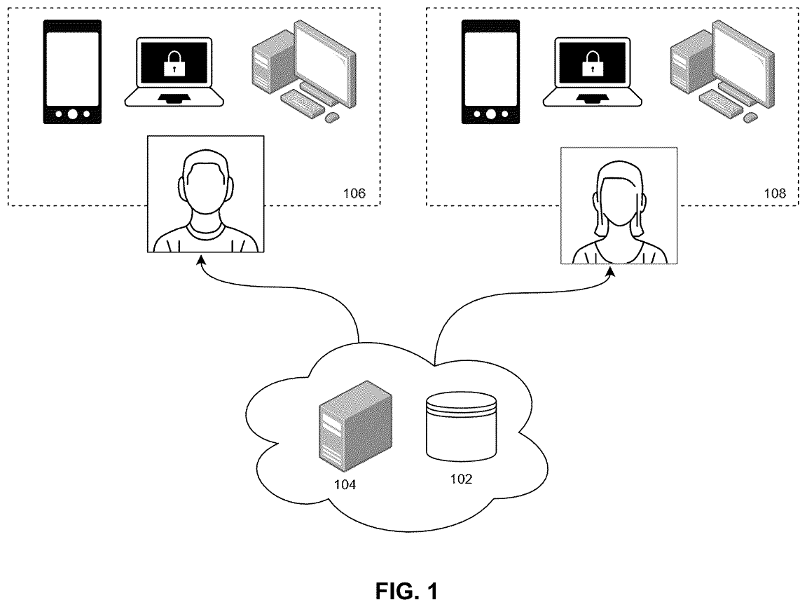

FIG. 1 presents a high-level system architecture for the web-based system designed for safeguarding professional license information. The figure illustrates a secure database (102) as the central repository for storing user information, including profiles of licensed professionals and government plan checker accounts. This database (102) is structured to maintain a high degree of data security and integrity, employing encryption and other security measures to protect sensitive information.

In communication with the secure database (102) are a set of servers (104). These servers (104) are depicted as being interconnected over a cloud network, indicating the system's potential use of cloud computing technologies for data processing and storage. The servers (104) are responsible for a range of functions including receiving license information, verifying this information through third-party services, and subsequently updating the database (102) with the authenticated data.

A first set of user devices (106), associated with the licensed professional accounts, is shown in communication with the servers (104). These devices (106) enable licensed professionals to submit their license information and project details to the system for verification and storage. The user devices (106) can range from personal computers to mobile devices, equipped with software applications or web interfaces to interact with the system.

Similarly, a second set of user devices (108), associated with government plan checker accounts, is also in communication with the servers (104). These devices (108) are used by government plan checkers to access the system for verifying the authenticity of professional license stamps on submitted projects. The devices (108) facilitate the submission of verification requests to the servers (104) and receive the results of these queries.

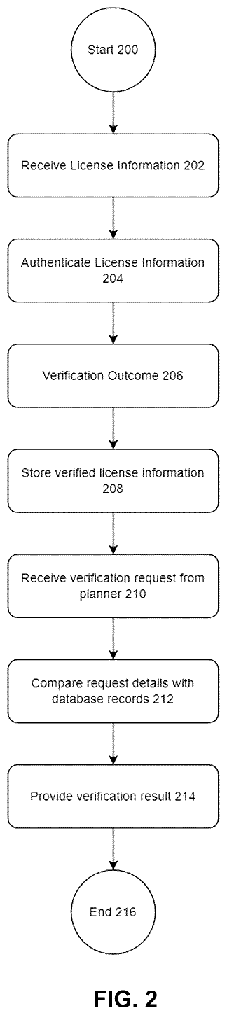

FIG. 2 in the patent illustrates a flow process diagram detailing the operational steps of the web-based system for safeguarding professional license information.

The process begins at Start (200), marking the initiation of the license verification procedure within the system. From this point, the flow moves to the first functional step, where the system Receives License Information (202) from a user device associated with a licensed professional account. In this step, licensed professionals input their license data into the system via their user devices, initiating the verification process.

Following the receipt of license information, the system progresses to Authenticate License Information (204). Here, the one or more servers transmit the received license details to a third-party verification service. This step ensures the validity and authenticity of the license information provided by the professional.

The next decision node, Verification Outcome (206), determines the result of the authentication process. If the license information is successfully verified, the flow proceeds; if not, there is a feedback mechanism for the professional to re-submit or correct the information.

Upon successful verification, the system Stores Verified License Information (208) in the secure database, associating it with the licensed professional's account. This step ensures that all verified license data is accurately recorded and securely maintained within the system.

The process then moves to Receive Verification Request (210), where the servers obtain a request from a government plan checker account. This request includes a specific project identifier and the license information of a professional, seeking confirmation of the project's authorization.

In Compare with Database Records (212), the servers compare the project and license identifiers from the request against the records in the secure database. This comparison is to ascertain if the project in question is listed under the professional's account.

The final step in the process is to Provide Verification Result (214) to the government plan checker account. Based on the comparison, the system confirms whether the project is authorized by the professional associated with the license identifier.

The flow concludes at End (216), indicating the completion of the verification process.

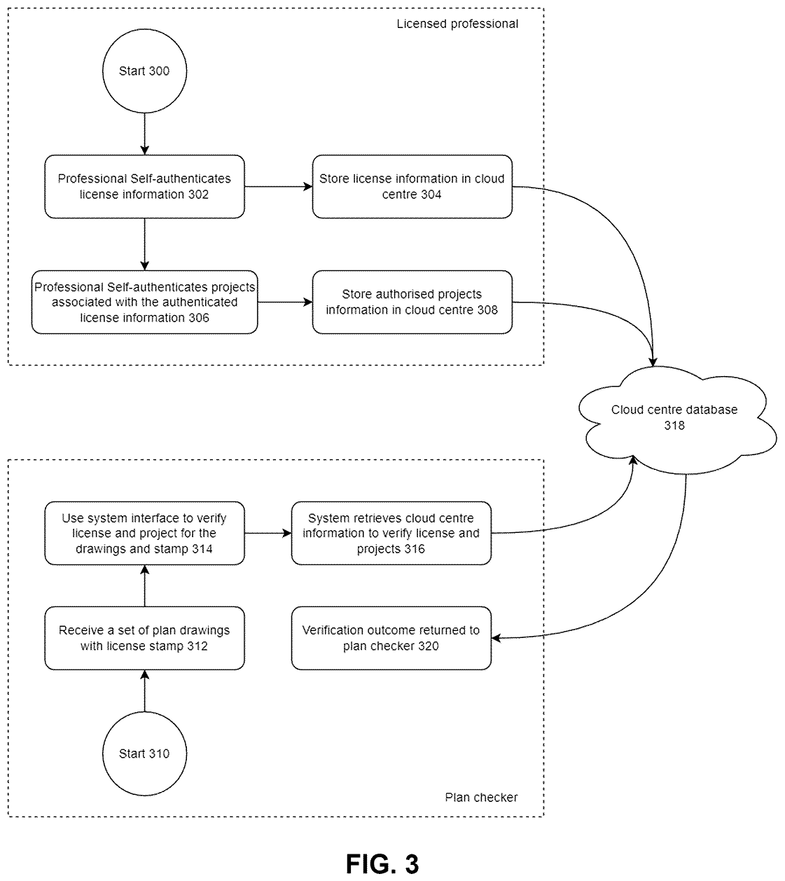

FIG. 3 illustrates a flowchart detailing the operational steps executed by licensed professional and plan checker accounts within the web-based system for safeguarding professional license information.

The flowchart initiates with Start (300), where a licensed professional begins the process of license authentication. The professional self-authenticates their license information at step (302), followed by storing this information in the cloud centre at step (304). Subsequently, the professional also self-authenticates projects associated with the authenticated license information at step (306) and stores this authorized project information in the cloud centre at step (308). These steps ensure that both the professional's credentials and their project details are securely recorded and maintained within the system, as indicated by their connection to the cloud centre database (318).

In a separate but related sequence, the flowchart depicts the actions of a plan checker starting at Start (310). The plan checker receives a set of plan drawings with a license stamp at step (312) and uses the system interface to verify the license and project for the drawings and stamp at step (314). This user interface step is pivotal in enabling the plan checker to interact with the system for verification purposes.

The system, at step (316), retrieves the necessary information from the cloud centre database (318) to verify the license and projects. This step signifies the interaction between the user-initiated query and the back-end database where all validated license and project information is stored.

Finally, the verification outcome is returned to the plan checker at step (320), completing the flow of operations. This step concludes the verification process, providing the plan checker with the necessary information to affirm the authenticity of the professional's license stamp on the submitted plans.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### CONCLUSION

The disclosed embodiments are illustrative, not restrictive. While specific configurations of the system and methods of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A web-based system for safeguarding professional license information, comprising:
a secure database configured to store user information including licensed professional accounts and government plan checker accounts, wherein the user information further includes a plurality of projects associated with each licensed professional account;
one or more servers in secure communication with the secure database, the servers being programmed to:
receive license information from a user device associated with a licensed professional account;
authenticate the received license information via a third-party verification service;
upon successful verification, store the authenticated license information in the secure database in association with the licensed professional's account;
wherein the one or more servers are further programmed to:
receive a verification request from a government plan checker account, the request including a project identifier and a license identifier of a licensed professional;
compare the project identifier and the license identifier with the projects associated with the licensed professional account in the secure database;
provide a verification result to the government plan checker account based on the comparison, thereby confirming whether the project is authorized by the licensed professional associated with the license identifier.

2. The web-based system of claim 1, wherein the user devices comprise a first set associated with the licensed professional accounts and a second set associated with the government plan checker accounts, each set having user interfaces configured with distinct permissions and functionalities relevant to the respective account types.

3. The web-based system of claim 1, wherein the secure database is further configured to categorize the user information based on at least one of a state, city, or license category.

4. The web-based system of claim 1, wherein each project in the plurality of projects associated with the licensed professional accounts is designated a specific project name and associated with unique project details.

5. The web-based system of claim 4, wherein the unique project details include information regarding the buyer who has ordered the work.

6. The web-based system of claim 1, wherein the user devices associated with the licensed professional accounts are further configured to enable the licensed professionals to upload their respective license information to the secure database for verification.

7. The web-based system of claim 1, wherein the one or more servers are further programmed to provide a verified indicator in association with the licensed professional's account upon successful storage of the license information.

8. The web-based system of claim 1, wherein the one or more servers are further programmed to implement predictive analytics to forecast potential unauthorized use of license information based on access patterns and provide alerts to the associated licensed professional account.

9. The web-based system of claim 1, wherein the verification request includes an input field for the government plan checker account to enter the license number and category of a stamp on a project for searching licensee information within the secure database.

10. The web-based system of claim 1, wherein the one or more servers are further configured to facilitate direct messaging between the government plan checker accounts and the licensed professional accounts for communication regarding verification results.

11. The web-based system of claim 1, wherein the secure database is further programmed to log verification requests and results to provide an audit trail for compliance and monitoring purposes.

12. The web-based system of claim 1, wherein the one or more servers are further programmed to employ encryption for data at rest within the secure database and during data transmission between the user devices and the secure database to ensure data security.

13. The web-based system of claim 1, wherein the user devices associated with the licensed professional accounts provide a dashboard interface to manage their active projects and display the verification status thereof.

14. The web-based system of claim 1, wherein the one or more servers are further programmed to facilitate the updating of license information by the licensed professional accounts to reflect current licensure status.

15. The web-based system of claim 1, wherein the system is provided as a Software as a Service (Saas) platform accessible via the internet to the user devices.
